(19) United States
(12) Patent Application Publication
(10) Pub. No.: US 2025/0185541 A1
(43) Pub. Date: Jun. 12, 2025

(54) Mower

(71) Applicant: CLAAS Saulgau GmbH, 88348 Bad Saulgau (DE)

(72) Inventors: Simon Frye, Bad Saulgau (DE); Sascha Pflanze, Braunenweiler (DE)

(21) Appl. No.: 18/975,355

(22) Filed: Dec. 10, 2024

(30) Foreign Application Priority Data
Dec. 11, 2023 (DE) 102023134641.5

(51) Int. Cl. A01D 43/10

(52) U.S. Cl. CPC A01D 43/10

(57) ABSTRACT

The invention relates to a mower (1), comprising a plurality of mowing elements positioned next to one another to form a mower bar (2), and comprising a roller conditioner (4), which is arranged behind the mower bar (2), as seen in the material flow direction of mowed crop (3), and which has an upper conditioning roller (5) and a lower conditioning roller (6), wherein a gap between the conditioning rollers (5, 6) through which the crop (3) is transported is variable depending on an amount of the crop (3), and wherein a device for recognizing or for finding foreign bodies (12) in the mowed crop (3) is provided. (FIG. 2)

The invention relates to a mower according to the preamble of Patent claim 1.

DE 10 2020 124 992 A1 discloses a mower comprising a plurality of mowing elements positioned next to one another to form a mower bar, and comprising a roller conditioner, which is arranged behind the mower bar, as seen in the material flow direction of mowed crop, and which has an upper conditioning roller and a lower conditioning roller, wherein the lower conditioning roller is rotatable about a lower, positionally fixed axis of rotation, wherein the upper conditioning roller is rotatable about an upper, shiftable axis of rotation in such a way that a gap between the conditioning rollers is variable owing to the upper axis of rotation being shifted relative to the lower axis of rotation.

During the harvesting of grass, alfalfas or similar crops using a mower operated by a tractor as a carrier vehicle, harmful foreign bodies, such as stones or pieces of wood, in the crop are not detected until in the last work step, and even then only if a correspondingly equipped forage harvester is used instead of a loading wagon or instead of a baler for taking away the crop.

Taking this as a departure point, the object of the invention is to provide a novel mower.

This object is achieved according to the invention by the characterizing features of Patent claim 1.

A mower according to the invention has a mower bar comprising a plurality of mowing elements positioned next to one another, and downstream of the mower bar there is disposed a roller conditioner behind the mower bar, as seen in the material flow direction of mowed crop, which roller conditioner has an upper conditioning roller and a lower conditioning roller, wherein a gap between the conditioning rollers through which the crop is transported is variable depending on an amount of the crop, and wherein a device for recognizing or for finding foreign bodies in the mowed crop is provided.

The use of a device for recognizing or for finding foreign bodies, in particular stones, on the mower enables harmful foreign bodies already to be found at an early stage and removed from the meadow or from the crop. As a result, damage to following machines can be particularly advantageously prevented.

In accordance with one advantageous development, the lower conditioning roller is mounted so as to be rotatable about a lower, positionally fixed axis of rotation and the upper conditioning roller, in order to adapt the gap to the amount of crop, is mounted so as to be rotatable about an upper, shiftable axis of rotation, such that the upper axis of rotation is shiftable relative to the lower axis of rotation, wherein the upper axis of rotation is arranged pivotably with respect thereto on levers and an angle sensor is provided, which continuously captures the deflection of a lever and communicates the captured measurement signals to a control device configured continuously to determine a distance between the axes of rotation of the conditioning rollers from the measurement signals of the angle sensor and to derive a velocity and/or an acceleration from the distance. In the event of a predefined value of the velocity and/or the acceleration being exceeded, the control device advantageously generates a signal for the finding of a foreign body in the crop.

According to a further advantageous development, the upper conditioning roller is mounted in each case pivotably on a lever at both ends of said roller and an angle sensor is provided on each lever, both of which angle sensors communicate the captured measurement signals to the control device, and the control device compares the distances and/or the values of the acceleration and/or the velocity from the two angle sensors with one another and determines therefrom the position of the foreign body in the direction of the width of the conditioning rollers. This advantageously makes it easier for an operator to remove the foreign body from the crop.

According to a further advantageous development, provision is made for the control device to generate the signal for the finding of a foreign body only if at the same time the distance between the axes of rotation also exceeds a predefined value. Incorrect initiations can advantageously be avoided as a result.

According to a further advantageous development, for the purpose of recognizing foreign bodies, as an alternative or in addition to angle sensors, an acceleration sensor is provided, which determines the acceleration of the upper shiftable conditioning roller in the vertical direction and communicates the acceleration values to the control device, which, in the event of a predefined value of the acceleration being exceeded, generates a signal for the finding of a foreign body. The acceleration sensor is preferably arranged on an end face of the upper conditioning roller. Particularly preferably, an acceleration sensor is arranged on both end faces or on both longitudinal ends of the upper conditioning roller and both acceleration sensors communicate the acceleration values to the control device. The control device compares the acceleration values from the two acceleration sensors with one another and determines therefrom the position of the foreign body in the direction of the width of the conditioning rollers. This advantageously makes it easier for an operator to remove the foreign body from the crop.

The acceleration sensor(s) is/are preferably arranged on the mower in such a way as to be moved in the event of the upper conditioning roller being shifted over a long displacement, as a result of which large accelerations are advantageously measurable.

According to a further advantageous development, the control device of the mower is configured to receive position data from a GPS system and, in the event of a foreign body being found or recognized, to store the position data thereof. On the basis of the position data, it is possible to generate indications for following agricultural machines in the harvesting chain, in order to warn their drivers or operators in good time prior to reaching the position of the foreign body.

Preferred developments of the invention are evident from the dependent claims and the description. The features of the present invention are explained in greater detail below on the basis of exemplary embodiments, without being restricted thereto. In the associated schematic drawings,

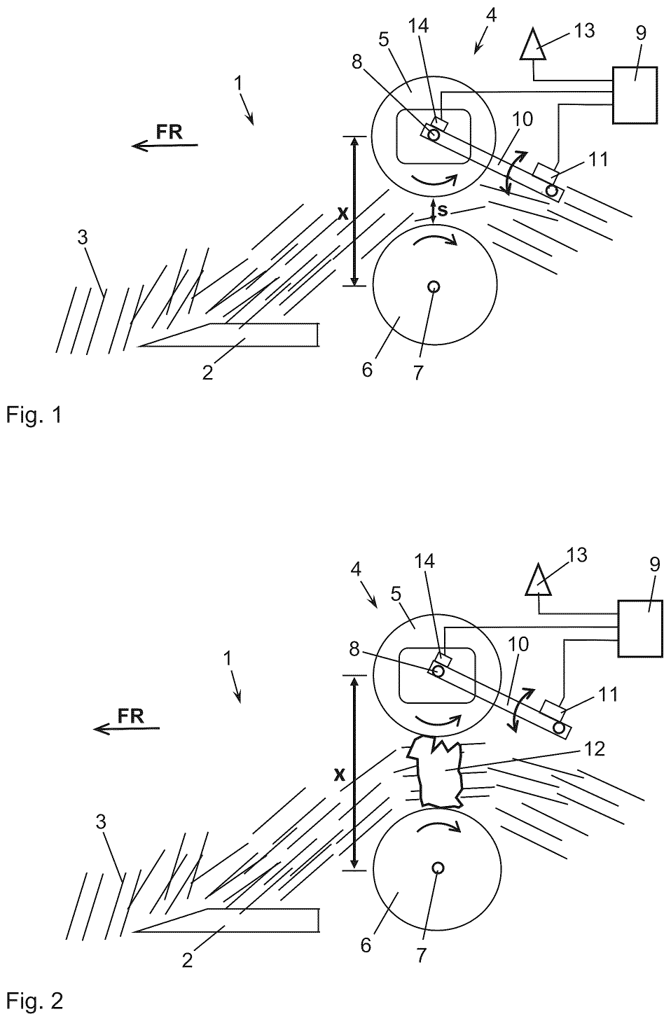

FIG. 1 shows a side view of a mower according to the invention during harvesting operation,

FIG. 2 shows a side view of a mower according to the invention during harvesting operation with a foreign body, and

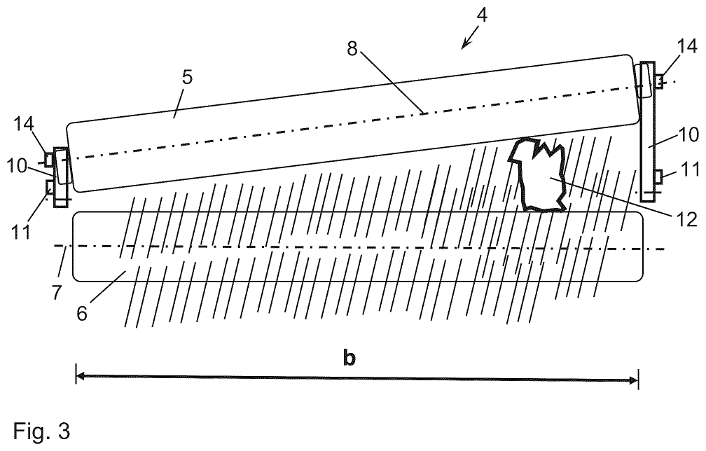

FIG. 3 shows a view of a mower according to the invention with a foreign body in the material flow direction of mowed crop.

FIG. 1 shows a highly schematic side view of a mower 1 according to the invention comprising a mower bar 2, which consists of a plurality of mowing elements positioned next to one another and downstream of which, as seen in the material flow direction of mowed crop 3, there is disposed a roller conditioner 4. The roller conditioner 4 comprises an upper conditioning roller 5 and a lower conditioning roller 6, between which a gap s is formed and between which the crop 3 is transported through. In this view, the upper conditioning roller 5 rotates in the anticlockwise direction about an axis of rotation 8 and the lower conditioning roller 6 rotates in the clockwise direction about a lower axis of rotation 7, wherein the gap s changes depending on an amount of the crop 3 which is transported through or conveyed through between the conditioning rollers 5, 6.

The mower 1 is taken up, driven and moved in the travel direction FR for the harvesting process by a carrier vehicle, such as a tractor, in a generally known manner.

The lower axis of rotation 7 of the lower conditioning roller 6 is arranged in a positionally fixed manner and the upper axis of rotation 8 of the upper conditioning roller 5 is arranged so as to be shiftable in order to adapt the gap s to the amount of crop 3, with the result that the distance x between the axes of rotation 7, 8 and the width of the gap s can change. For this purpose, the upper axis of rotation 8 is arranged pivotably on levers 10 and an angle sensor 11 is provided on one of the levers 10, which angle sensor continuously captures the deflection of the lever 10 and communicates the captured measurement signals to a control device 9.

The control device 9 is configured such that, from the measurement values from the angle sensor 11 that are communicated to the control device, and from the geometry data of the lever 10 that are stored in the control device, the control device continuously calculates the width of the gap s or the distance x between the axes of rotation 7, 8 of the two conditioning rollers 5, 6 and derives a velocity and/or an acceleration of the vertical movement of the upper conditioning roller 5 from the changing distance x. As soon as the control device 9 recognizes that a predefined value of the velocity and/or the acceleration has been exceeded, it generates a signal for the finding or recognizing of a foreign body 12 in the crop 3.

FIG. 2 shows a further highly schematic side view of a mower 1 according to the invention with a foreign body 12 in the crop 3. It is clear that the distance x between the axes of rotation 7, 8 and the gap s between the conditioning rollers 5, 6 are significantly larger than in FIG. 1 on account of the foreign body 12.

FIG. 3 shows a view of the mower 1 in the flow direction of the mowed crop 3, with a foreign body 12 having got between the conditioning rollers 5, 6. The foreign body 12 is situated to the right of the centre of the conditioning rollers 5, 6 and has had the effect that the upper conditioning roller 5 has inclined somewhat, or in other words has tilted, relative to the lower conditioning roller 6. Furthermore, it is evident in FIG. 3 that the upper conditioning roller 5 is mounted in each case pivotably on a lever 10 at both ends or end faces of said roller in order to adapt the distance x or the gap s to different amounts of crop 3. In this case, an angle sensor 11 is preferably provided on each lever 10, both of which angle sensors communicate the captured measurement signals to the control device 9.

The control device 9 compares the distances x and/or the values of the acceleration and/or the velocity from the two angle sensors 11 with one another and determines therefrom the position of the foreign body 12 in the direction of the width b of the conditioning rollers 5, 6.

In order to reduce or avoid errors in the case of recognizing or finding foreign bodies, provision can be made for the control device 9 to generate the signal for the finding of a foreign body 12 only if at the same time the distance x also exceeds a predefined value.

As an alternative or in addition to the angle sensor 11, for the purpose of recognizing foreign bodies 12, an acceleration sensor 14 can be provided, which determines the acceleration of the upper conditioning roller 5 in the vertical direction and communicates the acceleration values to the control device 9. In the event of a predefined value of the acceleration being exceeded, the control device 9 generates a signal for the finding of a foreign body 12. The acceleration sensor 14 is preferably arranged on an end face or on a longitudinal end of the upper conditioning roller 5.

Particularly preferably, respective acceleration sensors 14 are arranged on both end faces of the upper conditioning roller 5 and both acceleration sensors communicate the acceleration values to the control device 9. The control device 9 compares the acceleration values from the two acceleration sensors 14 with one another and determines therefrom the position of the foreign body 12 in the direction of the width b of the conditioning rollers 5, 6.

Furthermore, the control device 9 is preferably configured to receive position data from a GPS system 13 for ascertaining the current position of the mower 1 and, in the event of a foreign body 12 being found or recognized, to store the position data thereof.

The control device 9 can provide the position data of the foreign bodies 12 found to a superordinate data system that can be accessed by other machines involved in the harvesting chain. A superordinate control system or control devices of following agricultural machines in the harvesting chain can generate indications therefrom in order to warn the drivers or operators about the foreign bodies 12 at an early stage.

Preferably, a display is provided for the driver of the carrier vehicle that has taken up the mower 1 according to the invention, said display displaying a foreign body finding to the driver. The display used can be for example an ISOBUS terminal—generally customary in agricultural equipment—or some other comparable display unit. If a foreign body finding is displayed to the driver, the latter can then decide whether to remove the foreign body directly or only later on the basis of the recorded GPS coordinates. If the driver has removed the foreign body directly, the driver can remove the coordinates of the foreign body from the database by way of an input device.

In the preceding description, the mower 1 has been illustrated very highly schematically and moreover only the component parts that are relevant to the present invention have been described. It goes without saying that a mower 1 according to the invention also has all further generally customary component parts that are sufficiently known to a person skilled in the art.

### LIST OF REFERENCE SIGNS

1 Mower
2 Mower bar
3 Crop
4 Roller conditioner
5 Conditioning roller
6 Conditioning roller
7 Axis of rotation
8 Axis of rotation
9 Control device
10 Lever
11 Angle sensor
12 Foreign body
13 GPS system
14 Acceleration sensor
x Distance
s Gap
b Width
FR Travel direction/Harvesting direction

1. A mower (1), comprising a plurality of mowing elements positioned next to one another to form a mower bar (2), and comprising a roller conditioner (4), which is arranged behind the mower bar (2), as seen in the material flow direction of mowed crop (3), and which has an upper conditioning roller (5) and a lower conditioning roller (6), wherein a gap between the conditioning rollers (5, 6) through which the crop (3) is transported is variable depending on an amount of the crop (3), characterized by a device for recognizing or for finding foreign bodies (12) in the mowed crop (3).

2. The mower (1) according to claim 1, characterized in that the lower conditioning roller (6) is rotatable about a lower, positionally fixed axis of rotation (7) and the upper conditioning roller (5), in order to adapt the gap to the amount of crop (3), is rotatable about an upper, shiftable axis of rotation (8), such that the upper axis of rotation (8) is shiftable relative to the lower axis of rotation (7), wherein the upper axis of rotation (8) is arranged pivotably with respect thereto on levers (10) and an angle sensor (11) is provided, which continuously captures the deflection of a lever (10) and communicates the captured measurement signals to a control device (9) configured continuously to determine a distance (x) between the axes of rotation (7, 8) of the conditioning rollers (5, 6) from the measurement signals of the angle sensor (11) and to derive a velocity and/or an acceleration from the changing distance (x), wherein in the event of a predefined value of the velocity and/or the acceleration being exceeded, the control device (9) generates a signal for the finding of a foreign body (12).

3. The mower (1) according to claim 2, characterized in that the upper conditioning roller (5) is mounted pivotably on a lever (10) at both ends of said roller and an angle sensor (11) is provided on each lever (10), both of which angle sensors communicate the captured measurement signals to the control device (9), and the control device (9) compares the distances (x) and the values of the acceleration and/or the velocity from the two angle sensors (11) with one another and determines therefrom the position of the foreign body (12) in the direction of the width (b) of the conditioning rollers (5, 6).

4. The mower (1) according to claim 2, characterized in that the control device (9) generates the signal for the finding of a foreign body (12) only if the distance (x) also exceeds a predefined value.

5. The mower (1) according to claim 1, characterized in that the lower conditioning roller (6) is rotatable about a lower, positionally fixed axis of rotation (7) and the upper conditioning roller (5), in order to adapt the gap to the amount of crop (3), is rotatable about an upper, shiftable axis of rotation (8), such that the upper axis of rotation (8) is shiftable relative to the lower axis of rotation (7), wherein the vertical distance (x) between the axes of rotation (7, 8) changes and, for the purpose of recognizing foreign bodies (12), an acceleration sensor (14) is provided, which determines the acceleration of the upper conditioning roller (5) in the vertical direction and communicates the acceleration values to a control device (9), which, in the event of a predefined value of the acceleration being exceeded, generates a signal for the finding of a foreign body (12).

6. The mower (1) according to claim 5, characterized in that the acceleration sensor (14) is arranged on an end face of the upper conditioning roller (5).

7. The mower (1) according to claim 5, characterized in that an acceleration sensor (14) is arranged on both end faces of the upper conditioning roller (5) and both acceleration sensors (14) communicate the acceleration values to the control device (9), and the control device (9) compares the acceleration values from the two acceleration sensors (14) with one another and determines therefrom the position of the foreign body (12) in the direction of the width (b) of the conditioning rollers (5, 6).

8. The mower (1) according to claim 1, characterized in that a control device (9) of the mower (1) is configured to receive position data from a GPS system (13) and, in the event of a foreign body (12) being found or recognized, to store the position data thereof.
